(19) United States
(12) Patent Application Publication
(10) Pub. No.: US 2002/0118315 A1
(43) Pub. Date: Aug. 29, 2002

(54) Hard disk module for modular television and a method for recording and reproducing using the same

(75) Inventor: Joo-sun Hong, Suwon-city (KR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: SAMSUNG ELECTRONICS CO., LTD.

(21) Appl. No.: 10/054,890

(22) Filed: Jan. 25, 2002

(30) Foreign Application Priority Data
Feb. 26, 2001 (KR) KPA 2001-9573

(51) Int. Cl. H04N 5/64

(52) U.S. Cl. 348/839; 386/56

(57) ABSTRACT

A hard disk module for a modular television for easily recording and reproducing a huge amount of data in and from a hard disk, and a method for recording and reproducing using the same, is disclosed.

The recording method of the hard disk module includes the steps of storing the data in the buffer in the form of a transmission stream, the data being received from the main board mounted on the modular television via the interface portion, transmitting an IRQ signal to the control portion by the recording and reproducing portion when the predetermined amount of the data is stored in the buffer, and transmitting and storing the data, which is stored in the buffer, to the hard disk by the recording and reproducing portion in accordance with the DMA method.

### BACKGROUND OF THE INVENTION

1. Field of the Invention

The present invention relates to a hard disk drive (HDD) module for a modular television, and more particularly to a hard disk module for a modular television that transmits and receives data between a digital television and a hard disk. The present invention is based on Korean Patent Application No. 2001-9573, which is incorporated herein by reference.

2. Description of the Related Art

Multimedia apparatuses have been updated with functions thereof that operate at a high speed. Accordingly, a digital television for performing such multimedia functions has also been required to upgrade the functions thereof to be able to functionally accommodate new types of multimedia apparatuses. However, a general television has a shortcoming of restricting an upgrade level and thus, a digital television of a new concept such as a modular television has been recently developed to overcome this shortcoming.

The modular television is a digital television that has a main board for connecting to modules of diverse functions. The main board performs a function of mutual data transmission and reception between the modules and the digital television. Accordingly, when a new unprecedented multimedia function is developed, the digital television can easily be adapted to perform the new multimedia function by installing a module designed to perform the new multimedia function on the main board.

FIGS. 1 and 2 show the modular television. The modular television comprises a module rack 16 disposed on a supporter 10 and a display portion 18 disposed on an upper portion of the module rack 16. There is a door 14 disposed at a front face of the module rack 16 and speakers 12 disposed at both sides of the module rack 16. The door opens and closes the module rack 16.

FIG. 2 shows the module rack 16 on which seven (7) modules are mounted. The modules of various functions are selected and mounted on the module rack 16 in accordance with a user's needs. For example, in FIG. 2, a module 16b at an upper-most end is for a digital videocassette recorder (DVCR) function. Also, there is an insert opening 16a disposed at the uppermost end of the module rack 16 for inserting the digital videotape therethrough. The modules are installed on a main board that is disposed inside the module rack 16.

FIG. 3 is a view showing a connection terminal of a main board 100 disposed inside the module rack 16. FIG. 4 is a view showing a connection terminal of a module 200 connected to the main board 100 of the modular television. The main board 100 has interface ports 112 and 114 disposed therein for interfacing with the respective modules 200 therethrough. Also, the module 200 has interface ports 292 and 294 for connecting to the interface ports 112 and 114 of the main board 100. The RS232C, Peripheral Component Microchannel Interconnect Architecture (PCMCIA), IIC, Institute of Electrical & Electronics Engineers (IEEE) 1394 standards, and the like can be used as the interface ports 112, 114, 292, and 294 as required by the characteristics of the main board 100 and the module 200 connected to the main board 100. Preferably, a modular television according to the present invention has the IEEE 1394 ports as the interface ports 112, 114, 292, and 294 in the main board 100 and the module 200 connected to the main board 100. The IEEE 1394 ports transmit and receive data according to the IEEE 1394 protocol. If the module 200 is mounted in one of the slots disposed on the module rack 16, the interface ports 112 and 114 of the main board 100 are respectively connected to the interface ports 292 and 294 of the module 200 such that the module 200 interfaces with the main board 100.

Also, there is a power connector 110 and a detecting potion 118 in the main board 100 and another power connector 296 in the module 200. If the module 200 is mounted on the main board 100, the respective power connectors 110 and 296 are electrically connected to each other such that the power is supplied to the module 200 through the main board 100. The detecting portion 118 generates a detecting signal for informing the main board 100 that the module 200 is mounted on the main board 100.

According to the modular television as described above, the digital television can perform a new function by mounting a module with the new function on the main board 100.

Among the existing modules of various multimedia functions, such as a module of a MP3 player function, none could record a huge mass of data and reproduce the recorded huge mass of data as necessary. When a user would like to record the data received through a terrestrial broadcast, a cable broadcast, or a satellite broadcast, conventionally, the digital television has to record the data by means of a digital videotape that is additionally mounted at an appropriate place such as the DVCR module. Thus, there is a limitation on the amount of data which can be recorded and a speed thereof, and it is inconvenient to search the recorded data and then output the desired data. Accordingly, there has been an increasing demand for an apparatus and method for easily recording and reproducing a huge mass of data.

### SUMMARY OF THE INVENTION

The present invention is developed to solve the above problem, and an object of the present invention is to provide a hard disk module for a modular television that can easily record and reproduce data.

According to the present invention, in order to achieve the above object, a hard disk module for a modular television includes an interface portion for receiving and transmitting data from and to a main board in a transmission stream type, the main board mounted on the modular television, a memory having a program stored therein for controlling all of the components connected to a bus disposed inside a module, a recording and reproducing portion for recording the data in the hard disk and reproducing the data recorded in the hard disk, and a control portion for controlling the recording and reproducing portion such that the recording and reproducing portion records in the hard disk the data provided from the main board through the interface portion when in a recording mode, and when in a reproducing mode, reproduces the data recorded in the hard disk, and provides the reproduced data to the main board through the interface portion.

The above object is achieved by a recording method and a reproducing method of the hard disk module for the modular television, the recording method including the steps of storing the data in the buffer in the form of a transmission stream, the data received from the main board mounted on the modular television via the interface portion, transmitting an interrupt request (IRQ) signal to the control portion through the recording and reproducing portion when a predetermined amount of data is stored in the buffer, and transmitting and storing the data which is stored in the buffer to the hard disk by the recording and reproducing portion in accordance with the DMA (direct memory access) method; the reproducing method including the steps of initializing the hard disk by the control portion and transmitting the DMA command to the recording and reproducing portion, receiving the data from the hard disk by the recording and reproducing portion in accordance with the DMA command and then storing the data in the buffer, transmitting the IRQ signal to the control portion by the recording and reproducing portion when the preferred amount of data is stored in the buffer, and transmitting the data to the main board via the interface portion in accordance with the DMA method.

The above object is also achieved by a computer-readable recording medium for storing program codes for performing a recording method of a hard disk module for a modular television, the recording method including the steps of: storing data in a buffer in a form of a transmission stream, wherein the data is received from a main board mounted on the modular television via an interface portion; transmitting an interrupt request (IRQ) signal to a control portion via a recording and reproducing portion when a predetermined amount of data is stored in the buffer; and transmitting and storing the predetermined amount of data which is stored in the buffer, to a hard disk through the recording and reproducing portion in accordance with a direct memory access (DMA) method.

Further, the above object is also achieved by a computer-readable recording medium for storing program codes for performing a reproducing method of a hard disk module for a modular television, the reproducing method including the steps of: initializing a hard disk by a control portion and transmitting a direct memory access (DMA) command to a recording and reproducing portion; receiving data from the hard disk through the recording and reproducing portion in accordance with the DMA command and then storing the data in a buffer; transmitting an interrupt request (IRQ) signal to the control portion through the recording and reproducing portion when a preferred amount of data is stored in the buffer; and transmitting the data to the main board through an interface portion in accordance with a DMA method.

Yet further, the above object is also achieved by a computer system for performing a recording method of a hard disk module for a modular television, comprising: a processor, and a memory under control of said processor; wherein said memory includes instructions for enabling said processor to perform said recording method, the recording method including the steps of: storing data in a buffer in a form of a transmission stream, wherein the data is received from a main board mounted on the modular television via an interface portion; transmitting an interrupt request (IRQ) signal to a control portion via a recording and reproducing portion when a predetermined amount of data is stored in the buffer; and transmitting and storing the predetermined amount of data which is stored in the buffer, to a hard disk through the recording and reproducing portion in accordance with a direct memory access (DMA) method.

Finally, the above object is also achieved by a computer system for performing a reproducing method of a hard disk module for a modular television, comprising: a processor; and a memory under control of said processor; wherein said memory includes instructions for enabling said processor to perform said reproducing method, the reproducing method including the steps of: initializing a hard disk by a control portion and transmitting a direct memory access (DMA) command to a recording and reproducing portion; receiving data from the hard disk through the recording and reproducing portion in accordance with the DMA command and then storing the data in a buffer; transmitting an interrupt request (IRQ) signal to the control portion through the recording and reproducing portion when a preferred amount of data is stored in the buffer; and transmitting the data to the main board through an interface portion in accordance with a DMA method.

### BRIEF DESCRIPTION OF THE DRAWINGS

The object and advantages of the present invention will be more apparent from the following detailed description of the preferred embodiment of the invention in conjunction with the accompanying drawings, in which:

FIG. 1 is a front view of a modular television showing a state in which a door of a module rack is closed;

FIG. 2 is a front view of the modular television of FIG. 1 showing a state in which the door of the module rack is opened;

FIG. 3 is a view showing a connection terminal of a main board installed within the module rack of FIG. 2;

FIG. 4 is a view showing a connection terminal of a module connected to the main board of the modular television of FIG. 3;

FIG. 5 is a block diagram illustrating a system on which a hard disk module is mounted in accordance with the present invention;

FIG. 6 is a view showing a hard disk module according to a preferred embodiment of the present invention;

FIG. 7 is a flowchart explaining a recording mode of a hard disk module according to the present invention; and

FIG. 8 is a flowchart explaining a reproducing mode of a hard disk module according to the present invention.

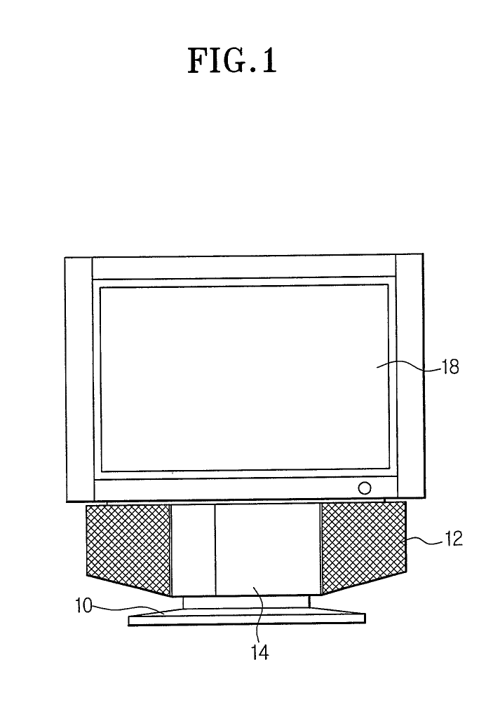

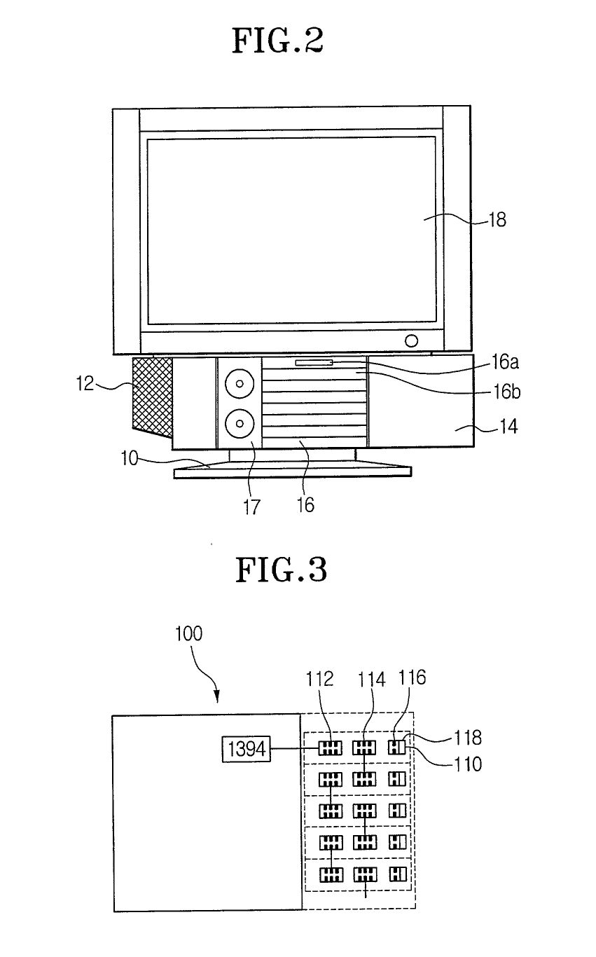

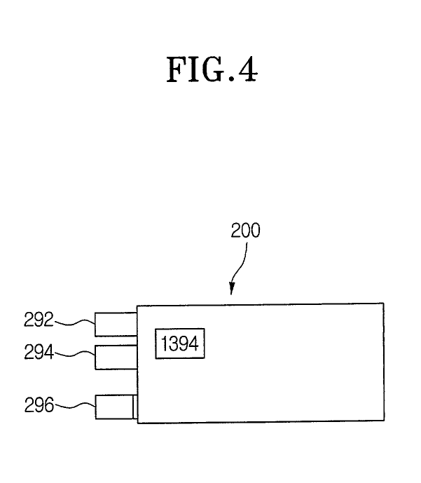

### DETAILED DESCRIPTION OF THE PREFERRED EMBODIMENT

Hereinafter, a preferred embodiment of the present invention is described in greater detail with reference to the accompanying reference drawings.

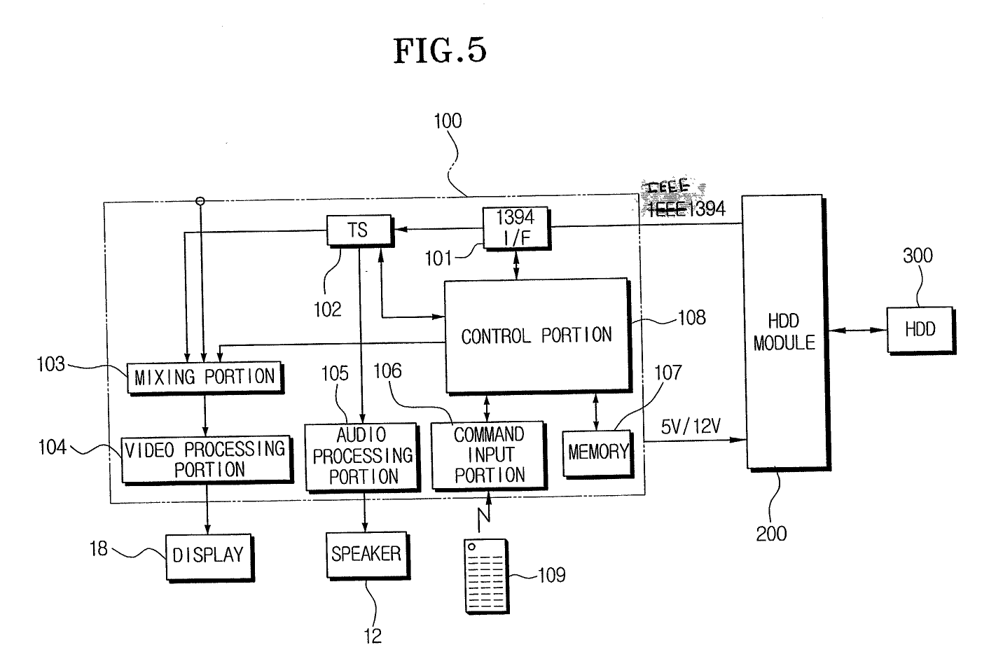

FIG. 5 is a block diagram showing a system on which a hard disk module according to the present invention is mounted. The system can be, for example, a computer system. A main board 100 includes an IEEE 1394 interface portion 101, a data transport stream (TS) processing portion 102, a mixing portion 103, a video processing portion 104, an audio processing portion 105, a command input portion 106, a memory 107, a control portion 108, and a remote control 109.

The IEEE 1394 interface portion 101 transmits and receives signals such as a MPEG (Moving Picture Experts Group) standard data transport stream, and status and control signals in the IEEE 1394 signal format. The IEEE 1394 interface portion 101 provides the data transport stream processing portion 102 with the received MPEG standard data transport stream. Also, the IEEE 1394 interface portion 101 provides the control portion 108 with the status and control signals.

The data transport stream processing portion 102 receives the MPEG standard data stream from the IEEE 1394 interface portion 101 and then decodes compressed data according to the MPEG standard. The data transport stream processing portion 102 provides the video processing portion 104 with decoded video data via the mixing portion 103 and provides the audio processing portion 105 with decoded audio data.

The video data overlaps with external video input data or graphic data at the mixing portion 103 and then is provided to the video processing portion 104.

The video processing portion 104 processes the video and graphic data overlapping each other and provides a display 18 with the processed data and the display 18 displays the data on a screen. The display 18 may be a displaying apparatus such as a CRT (cathode ray tube), a FLCD (ferro liquid crystal display), a FED (field emission display), a PDP (plasma display panel), or a projection type displaying apparatus.

The audio processing portion 105 processes the received audio data and outputs the processed data through a speaker 12 in the form of sound.

The command input portion 106 receives a user's command that is provided by the remote control 109 and a command key, and transmits the user's command to the control portion 108.

The memory 107 includes a random-access memory (RAM), a read-only memory (ROM), and a flash memory. The RAM is utilized as an image buffer for processing user interface graphic data. The ROM stores a control program of a modular television for operating as a web browser therein. The flash memory stores internet protocol (IP) addresses of the respective modules therein.

The control portion 108 operates the control program of the modular television stored in the ROM to control each circuit portion. Also, the control portion 108 detects whether the respective modules are mounted or not by a mounting detecting means (not shown), and controls a switching means (not shown) in response to the detected information on the mounting status, in order to automatically process a daisy chain connection between the modules.

The remote control 109 allows a user to control the modular television in changing a channel, selecting a module, and recording and reproducing a program at a predetermined distance away from the modular television. The user may also change a channel, select a module, and record and reproduce a program directly using the command key formed on the modular television.

A module 200 may interface with the other modules mounted on the main board 100. Here, the other modules include a digital terrestrial broadcast receiving module, a digital open cable converter module, a digital satellite broadcast receiving module, a disk drive module for a DVD or a HDD, an Internet connection module such as a modem, a MP3 recording and reproducing module, a digital video tape recorder (DVCR) module, and the like.

If the user selects a video and an audio program through the remote control 109 or the command key, and selects a command to record the selected program in a hard disk 300, then the command input portion 106 transmits the user's command to the control portion 108. The control portion 108 detects the PID (process identifier) information of the video and the audio program and searches the selected program in accordance with the detected information, and transmits the selected program to the data transport stream processing portion 102. The data transport stream processing portion 102 converts the received program into transport stream type data and then transmits the converted data to the control portion 108. The control portion 108 transmits the transport stream type data received from the data transport stream processing portion 102 to a hard disk module 200 for the modular television via the IEEE 1394 interface portion 101. The hard disk module 200 records the received data in the hard disk 300 that interfaces with the hard disk module 200.

If the user selects a command to reproduce the program recorded in the hard disk 300 using the remote control 109 or the command key, the command input portion 106 transmits the user's command to the control portion 108. Also, the memory 107 transmits the PID information of the selected program to the control portion 108 of the main board 100. The control portion 108 transmits the user's command and the PID information to the hard disk module 200 through the IEEE 1394 interface portion 101 and also receives data corresponding to the user's command from the hard disk module 200. At this time, since the data received from the hard disk module 200 has a transport stream type, as described above, the data is processed through the data transport stream processing portion 102, the mixing portion 103, the video processing portion 104, and the audio processing portion 105 and then the video and audio program selected with respect to the data is reproduced through the display 18 and the speaker 12.

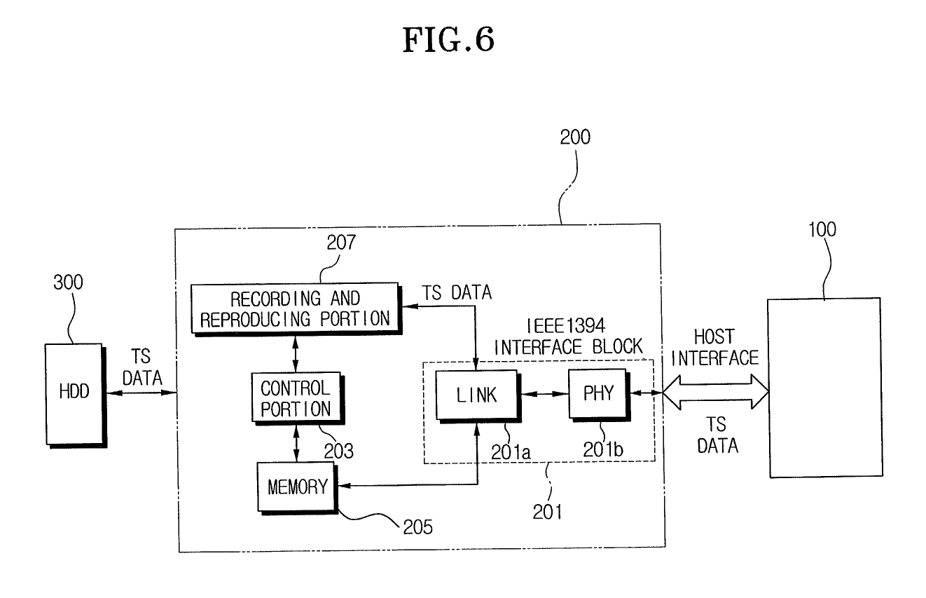

FIG. 6 is a view showing a hard disk module according to a preferred embodiment of the present invention. The hard disk module 200 includes an interface portion 201, a control portion (CPU) 203, a memory 205, and a recording and reproducing portion (HDD controller) 207. Also, the hard disk module 200 interfaces with the hard disk 300. It is preferable that the interface portion 201 uses the IEEE 1394 interface, the same one that is used by the main board 100. The IEEE 1394 interface is characterized by a high-speed transmission and bi-directional communication. The protocol of the IEEE 1394 is well established to cope with any changes in various systems connected to each other by the cable.

The IEEE 1394 interface portion 201 includes a 1394 link structure (LINK) 201a and a 1394 physical structure (PHY) 201b. The 1394 link structure 201a selects data or performs data formatting in accordance with the command from the control portion 203. The 1394 physical structure 201b functions to correct a signal distortion.

The interface portion 201 receives and processes data and a command of the transmit stream type of the video or the audio program from the main board 100. While the 1394 physical structure 201b of the interface portion 201 corrects the signal distortion of the data, the 1394 link structure 201a selects the corrected data and transmits the selected data to the memory 205 or to the recording and reproducing portion 207. If the data received at the interface portion 201 is a command to reproduce the data recorded in the hard disk 300, the interface portion 201 transmits the command to the memory 205. If the data received at the interface portion 201 is the data of the video or the audio program to be recorded in the hard disk 300, the interface portion 201 transmits the data to the recording and reproducing portion 207.

The memory 205 stores a program therein, the program for controlling all of the components connected to a bus that is disposed within the module. The program is downloaded from the main board 100, and is comprised of a command compatible with a program stored in the memory 107 of the main board 100.

The recording and reproducing portion 207 records the data received from the interface portion 201 in the hard disk 300 or outputs and transmits the data recorded in the hard disk 300 to the interface portion 201. First, the operation of recording and reproducing the data in the hard disk 300 by the recording and reproducing portion 207 will be described.

The recording and reproducing portion 207 receives the data of the video or the audio program from the control portion 108 of the main board 100 through the interface portion 201. The recording and reproducing portion 207 preferably includes a buffer (not illustrated).

The buffer stores a predetermined amount of the data therein by the “first-in first-out (FIFO) method” and then sequentially transmits the stored data to the hard disk 300. The amount of data stored in the buffer may be, for example 128 Kbytes according to the amount of data of the transmit stream type, the interfacing speed, etc.

If the predetermined amount of data is stored in the buffer, the program stored in the memory 205 transmits an interrupt request (IRQ) signal to the control portion 203. Then, if the control portion 203 receives the IRQ signal, the control portion 203 initializes the hard disk 300 and provides a direct memory access (DMA) command to the recording and reproducing portion 207. After receiving the DMA command, the recording and reproducing portion 207 can directly record the data in the hard disk 300 without passing through the control portion 203. That is achieved by a DMA method, i.e., by a structure in which the recording and reproducing portion 207 includes the buffer. Alternatively, a programmed input/output (PIO) method can also be used in which the recording and reproducing portion 207 records the data in the hard disk 300 via the control portion 203. In either case, the recording and reproducing portion 207 records data of the transmit stream type in the hard disk 300 without data conversion.

The control portion 203 controls all of the components connected to the bus that are disposed inside the module. Particularly, the control portion 203 controls the recording and reproducing portion 207 according to the program stored in the memory 205, such that the recording and reproducing portion 207 records the data which is provided from the main board 100 through the interface portion 201 in the hard disk 300 when in a recording mode. Also, as described above, the recording and reproducing portion 207 may directly record the data by the DMA method.

Next, reproducing the data recorded in the hard disk 300 will be described.

The memory 205 receives a command to reproduce the video or the audio program and the PID from the control portion 108 of the main board 100 via the interface portion 201. The memory 205 runs a program in accordance with the received command.

The control portion 203 initializes the hard disk 300 according to the program stored in the memory 205. Also, when the PIO command is transmitted from the memory 205 to the control portion 203, the control portion 203 controls the recording and reproducing portion 207 such that the recording and reproducing portion 207 reproduces the data recorded in the hard disk 300 when in a reproducing mode and provides the reproduced data to the main board 100 via the interface portion 201.

The recording and reproducing portion 207 directly detects the hard disk 300 in accordance with the received DMA command and runs the program for outputting the detected data. At this time, the output data is data of the transmit stream type. The output data is stored in the buffer. As described above, the buffer stores the predetermined amount of data, which is preferably 128 Kbytes of data. If the predetermined amount of data is stored in the buffer, the IRQ signal is provided to the control portion 203 according to the program stored in the memory 205. If the control portion 203 is interrupted, the recording and reproducing portion 207 transmits data of the transmit stream type stored in the buffer to the main board 100 via the interface portion 201. As described above, in absence of the buffer, it is possible to reproduce the data recorded in the hard disk 300 by the PIO method.

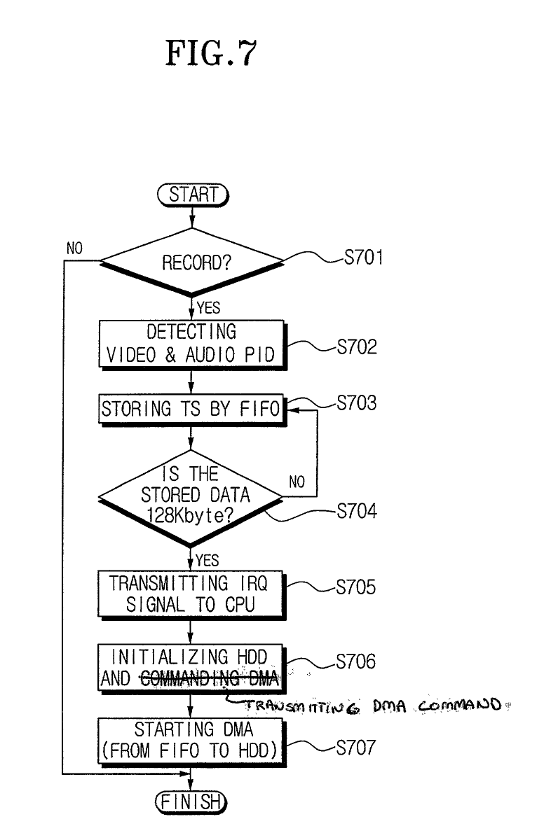

FIG. 7 is a flow chart explaining a recording mode of the hard disk module according to the present invention. A recording method of the hard disk module for the modular television according to the present invention includes the steps of storing the data in the buffer, wherein the data is received from the main board 100 mounted in the modular television via the interface portion 201 in the transmit stream type, transmitting the IRQ signal to the control portion 203 via the recording and reproducing process portion 207 when the predetermined amount of data is stored in the buffer, and transmitting and recording the data stored in the buffer to the hard disk 300 by the recording and reproducing portion 207 according to the DMA method.

If the user chooses to select the video and the audio programs and to record the selected programs in the hard disk 300, using the remote control 109 or the command key (S701), the command input portion 106 of the main board 100 transmits the user's command to the control portion 108 of the main board 100. The control portion 108 of the main board 100 detects the PID information of the video or the audio program (S702) and then searches and transmits a program selected in accordance with the detected information to the transport stream processing portion 102. The transmit stream processing portion 102 converts the received program into data of the transmit stream type and then transmits the converted program to the control portion 108 of the main board 100. The control portion 108 of the main board 100 transmits the data of the transport stream type, which is received from the transmit stream processing portion 102, to the interface portion 201 of the hard disk module 200 for the modular television via the interface portion 101 of the main board 100. Here, the interface portion 201 of the hard disk module 200 for the module television preferably uses the IEEE 1394 interface, the same one that is used by the main board 100.

The signal distortion of the data transmitted to the interface portion 201 is corrected by the 1394 physical structure 201b, and the data is selected by the 1394 link structure 201a to be transmitted to the recording and reproducing portion 207 to be recorded in the hard disk 300.

The recording and reproducing portion 207 stores data of the transmit stream type in the buffer by the first-in first-out method (S703). Here, the buffer (not illustrated) preferably stores 128 Kbytes of data, but the amount of data stored is determined according to the amount of data of the transmit stream type and the transmission speed. If the predetermined amount of data is stored in the buffer (S704), the recording and reproducing portion 207 informs the control portion 203 of the completion of storage in the buffer. The control portion 203 receives information on the completion of storage from the recording and reproducing portion 207 and then detects the program of the memory 205. Then, the memory 205 transmits the IRQ signal to the control portion 203 according to the program stored in the memory 205 (S705).

If the control portion 203 receives the IRQ signal, the control portion 203 initializes the hard disk 300 and allots an area for recording the data to the hard disk 300. Also, the control portion 203 transmits the DMA command to the recording and reproducing portion 207 (S706) such that the recording and reproducing portion 207 directly records the data, which is provided from the main board 100 via interface portion 201, in the hard disk 300 without passing through the control portion 203. Since it is possible to transmit the data by a block unit at once according to the DMA method and there is no intervention of the control portion 203, the data can be transmitted at a higher speed and further, the speed of the system is entirely increased.

If the recording and reproducing portion 207 receives the DMA command, the recording and reproducing portion 207 records in the hard disk 300 the data of the transmit stream type which is stored in the buffer. The recording of data in the hard disk 300 is repeated as the amount of data sequentially stored in the buffer reaches the predetermined amount. As described above, when the recording and reproducing portion 207 is in the recording mode, the video or audio program selected by the user is recorded in the hard disk 300 in the form of data of the transmit stream type.

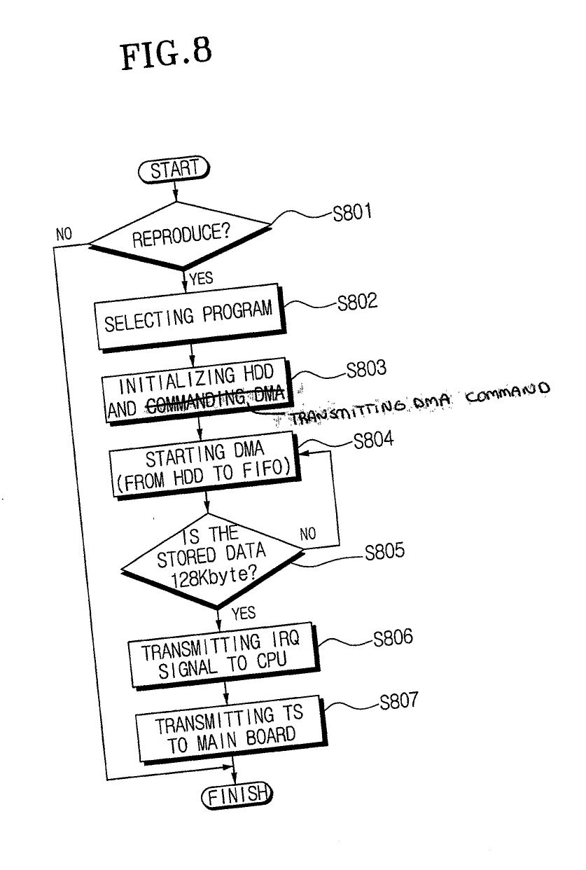

FIG. 8 is a flow chart explaining the reproducing mode of the hard disk module according to the present invention. A reproducing method of the hard disk module for the modular television according to the present invention includes the steps of initializing the hard disk 300 by the control portion 203 and transmitting the DMA command to the recording and reproducing portion 207, receiving the data from the hard disk 300 via the recording and reproducing portion 207 in accordance with the DMA command and storing the received data in the buffer, transmitting the IRQ signal to the control portion 203 via the recording and reproducing portion 207 when a preferred amount of the data is stored in the buffer, and transmitting the data to the main board 100 via the interface portion 101 according to the DMA method.

If the user chooses to reproduce a program recorded in the hard disk 300 using the remote control 109 or the command key (S801) and then selects and inputs the program to be reproduced (S802), the command input portion 106 of the main board 100 transmits the user's reproducing command to the control portion 108 of the main board 100. Also, the memory 107 transmits the PID information of the selected program to the control portion 108 of the main board 100. The control portion 108 of the main board 100 transmits the PID information to the interface portion 201 of the hard disk module 200 via the IEEE 1394 interface portion 101 along with the user's reproducing command.

The interface portion 201 corrects the signal distortion of the received reproducing command and the PID information at the 1394 physical structure 201b, and selects and transmits the data to the memory 205 at the 1394 link structure 201a in order to reproduce the data recorded in the hard disk 300.

The control portion 203 detects a program in the memory 205 in order to reproduce the video or the audio program which is selected according to the reproducing command and the PID information. At this time, the memory 205 transmits to the control portion 203 a corresponding reproducing program.

If the control portion 203 receives the program from the memory 205, the control portion 203 initializes the hard disk 300 and detects the data corresponding to the PID information of the selected program. Also, the control portion 203 transmits the DMA command to the recording and reproducing portion 207 (S803) and allows the recording and reproducing portion 207 to directly output the data from the hard disk 300 and to transmit the data to the interface portion 201.

If the recording and reproducing portion 207 receives the DMA command from the control portion 203, the recording and reproducing portion 207 outputs the data detected by the control portion 203 from the hard disk 300 and stores the data in the buffer (not illustrated) (S804). If the predetermined amount of the data is stored in the buffer (S805), the recording and reproducing portion 207 informs the control portion 203 of the completion of the storage in the buffer. Then, the control portion 203 detects the program of the memory 205. At this time, the IRQ signal is provided to the control portion 203 from the memory 205 according to the program stored in the memory 205 (S806). If the control portion 203 is interrupted by the IRQ signal, the recording and reproducing portion 207 transmits to the interface portion 201 data of the transmit stream type which is stored in the buffer. After the data stored in the buffer is transmitted to the interface portion 201, the next data is sequentially stored in the buffer, and the above operation is repeated. The interface portion 201 transmits the received data to the main board 100 (S807).

The IEEE 1394 interface 101 of the main board 100 receives data to be reproduced, from the interface portion 201 of the hard disk module 200.

At this time, since the data received from the hard disk module 200 is data of the transmit stream type, as described in FIG. 5, the control portion 108 of the main board 100 transmits the data received from the hard disk module 200 to the video processing portion 104 and the audio processing portion 105 via the transmit stream processing portion 102. The video processing portion 104 and the audio processing portion 105 reproduce the selected video or audio program with respect to the received data through the display 18 and the speaker 12, respectively.

Although the recording and reproducing method of the hard disk module for the modular television can use the DMA method, as an example of the present invention, the recording and reproducing method of the hard disk module should not be limited to the above embodiment, e.g., the PIO method can be alternatively used.

According to the present invention, it is possible to record and reproduce a huge amount of data in and from the hard disk by using the hard disk module for the modular television. Also the speed of recording and reproducing the data can be increased by the DMA method.

Also, the recording and reproducing method of the hard disk module for the modular television, according to the present invention, can be written as a program executed on a personal computer or server. The program codes and code segments constructing the program can be easily inferred by computer programmers in the industry. Furthermore, the program can be stored in a computer-readable recording medium. The recording medium includes, for example, a magnetic recording medium, an optical recording medium, and a radio medium.

Finally, although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A hard disk module for a modular television including:
an interface portion for receiving and transmitting data from and to a main board as a transmission stream, wherein the main board is mounted on the modular television;
a memory having a program stored therein for controlling the entire components connected to a bus disposed inside the hard disk module;
a recording and reproducing portion for recording the data in a hard disk and reproducing the data recorded in the hard disk; and
a control portion for controlling the recording and reproducing portion such that the recording and reproducing portion records in the hard disk the data provided from the main board through the interface portion when in a recording mode, and when in a reproducing mode, reproduces the data recorded in the hard disk, and provides the reproduced data to the main board through the interface portion.

2. The hard disk module of claim 1, wherein the recording and reproducing portion includes a buffer for sequentially storing a predetermined amount of data therein, wherein the predetermined amount of data is received from and transmitted to the interface portion.

3. The hard disk module of claim 2, wherein the interface portion uses an Institute of Electrical & Electronics Engineers (IEEE) 1394 bus.

4. A recording method of a hard disk module for a modular television including the steps of:
storing data in a buffer in a form of a transmission stream, wherein the data is received from a main board mounted on the modular television via an interface portion;
transmitting an interrupt request (IRQ) signal to a control portion via a recording and reproducing portion when a predetermined amount of data is stored in the buffer; and
transmitting and storing the predetermined amount of data which is stored in the buffer, to a hard disk through the recording and reproducing portion in accordance with a direct memory access (DMA) method.

5. The recording method of claim 4, further including the steps of initializing the hard disk by the control portion when the control portion receives the IRQ signal, and transmitting a DMA command to the recording and reproducing portion.

6. A reproducing method of a hard disk module for a modular television including the steps of:
initializing a hard disk by a control portion and transmitting a direct memory access (DMA) command to a recording and reproducing portion;
receiving data from the hard disk through the recording and reproducing portion in accordance with the DMA command and then storing the data in a buffer;
transmitting an interrupt request (IRQ) signal to the control portion through the recording and reproducing portion when a preferred amount of data is stored in the buffer; and
transmitting the data to the main board through an interface portion in accordance with a DMA method.

7. A computer-readable recording medium for storing program codes for performing a recording method of a hard disk module for a modular television, the recording method including the steps of:
storing data in a buffer in a form of a transmission stream, wherein the data is received from a main board mounted on the modular television via an interface portion;
transmitting an interrupt request (IRQ) signal to a control portion via a recording and reproducing portion when a predetermined amount of data is stored in the buffer; and
transmitting and storing the predetermined amount of data which is stored in the buffer, to a hard disk through the recording and reproducing portion in accordance with a direct memory access (DMA) method.

8. The computer-readable recording medium of claim 7, wherein the recording method further includes the steps of initializing the hard disk by the control portion when the control portion receives the IRQ signal, and transmitting a DMA command to the recording and reproducing portion.

9. A computer-readable recording medium for storing program codes for performing a reproducing method of a hard disk module for a modular television, the reproducing method including the steps of:
initializing a hard disk by a control portion and transmitting a direct memory access (DMA) command to a recording and reproducing portion;
receiving data from the hard disk through the recording and reproducing portion in accordance with the DMA command and then storing the data in a buffer;
transmitting an interrupt request (IRQ) signal to the control portion through the recording and reproducing portion when a preferred amount of data is stored in the buffer; and
transmitting the data to the main board through an interface portion in accordance with a DMA method.

10. A computer system for performing a recording method of a hard disk module for a modular television, comprising:
a processor, and
a memory under control of said processor;
wherein said memory includes instructions for enabling said processor to perform said recording method, the recording method including the steps of:
storing data in a buffer in a form of a transmission stream, wherein the data is received from a main board mounted on the modular television via an interface portion;
transmitting an interrupt request (IRQ) signal to a control portion via a recording and reproducing portion when a predetermined amount of data is stored in the buffer; and
transmitting and storing the predetermined amount of data which is stored in the buffer, to a hard disk through the recording and reproducing portion in accordance with a direct memory access (DMA) method.

11. The computer system of claim 10, wherein the recording method further includes the steps of initializing the hard disk by the control portion when the control portion receives the IRQ signal, and transmitting a DMA command to the recording and reproducing portion.

12. A computer system for performing a reproducing method of a hard disk module for a modular television, comprising:
a processor; and
a memory under control of said processor;
wherein said memory includes instructions for enabling said processor to perform said reproducing method, the reproducing method including the steps of:
initializing a hard disk by a control portion and transmitting a direct memory access (DMA) command to a recording and reproducing portion;
receiving data from the hard disk through the recording and reproducing portion in accordance with the DMA command and then storing the data in a buffer;
transmitting an interrupt request (IRQ) signal to the control portion through the recording and reproducing portion when a preferred amount of data is stored in the buffer; and
transmitting the data to the main board through an interface portion in accordance with a DMA method.
